(19) United States
(12) Patent Application Publication
(10) Pub. No.: US 2026/0348351 A1
(43) Pub. Date: Nov. 5, 2026

(54) METHOD FOR TUNING THE NATURAL FREQUENCY OF A WAVE ENERGY CONVERTER BY MANIPULATION OF THE EFFECTIVE GRAVITY VECTOR

(71) Applicant: Raphael Hon, Irvine, CA (US)

(72) Inventor: Raphael Hon, Irvine, CA (US)

(21) Appl. No.: 19/651,684

(22) Filed: Apr. 18, 2026

Related U.S. Application Data
(60) Provisional application No. 63/791,059, filed on Apr. 18, 2025.

(51) Int. Cl. F03B 13/20

(52) U.S. Cl. CPC F03B 13/20

(57) ABSTRACT

A method for tuning the natural frequency of a wave energy converter (WEC) to achieve resonance with a prevailing sea state by manipulating the effective gravity vector acting on the WEC. For a WEC having a translational power take-off (PTO), an inclination angle of a displacement path of a WEC body relative to gravity is adjusted, modifying the effective spring constant and the natural frequency. For a WEC having a rotational PTO, an equilibrium angle of a lever coupling two WEC bodies is adjusted relative to gravity, modifying the torsional spring constant and the natural frequency. The method is passive, requires no prediction of future waves, and may be combined with other tuning techniques. Spar-buoy embodiments enable adjustment of the inclination or equilibrium angle by changing the draft of the spar buoy in response to changing sea states.

### INCORPORATION BY REFERENCE TO ANY PRIORITY APPLICATIONS

This application claims the benefit of priority to U.S. Provisional Patent Application No. 63/791,059, filed on Apr. 18, 2025, which is incorporated by reference herein in its entirety for all purposes. Priority is claimed pursuant to 35 U.S.C. § 119.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, TABLE, OR COMPUTER PROGRAM LISTING

Not applicable.

### BACKGROUND OF THE INVENTION

### Field of the Invention

The present invention relates generally to wave energy converter (WEC) devices and, more particularly, to a method for tuning the natural frequency of a WEC to achieve resonance with a prevailing sea state by manipulating the effective vector of gravity acting on the WEC.

### Description of the Related Art

Wave Energy Converter (WEC) devices harvest renewable energy from ocean waves by converting the kinetic energy of waves into useful energy. Wave action drives the WEC's Power Take-Off (PTO) mechanism, which transforms the kinetic energy into a usable form such as electricity. Despite the enormous number of designs and prior art, WECs attempted to date have not been cost competitive in the marketplace. A large portion of WEC designs have floating bodies in water, while some have floating bodies moving relative to another body anchored to the sea floor.

A WEC is an oscillating mechanical system driven by the force of waves, and a WEC with a fixed body geometry and mass has a natural frequency of oscillation. The dynamics of WECs balance the wave forces with the forces of the PTO mechanism, gravity, and other forces acting on the WEC such as mooring lines. These WECs are typically modeled mathematically with an equivalent mass, spring, and damper oscillating system.

The cost of wave energy is reduced when wave energy harvest is increased, and one way to increase a WEC's energy output is for the oscillating system to be in resonance with the prevailing sea state. However, ocean waves occur in a range of frequencies and the resonant frequency for a typical WEC occurs only part of the time. In fact, most WECs do not generate much energy at wave frequencies that are not near the WEC's natural frequency. WECs are currently not economically viable because of insufficient energy output.

Significant attempts have been made to enable WECs to achieve resonance across the range of natural wave frequencies. A variety of methods have been introduced and attempted, but these have not been shown to reduce the overall cost of wave energy and are not commercially successful. Many known methods to achieve resonance have a limited range of effectiveness, are not practical, or require substantial costs.

Accordingly, a need exists for a WEC that can be easily manipulated to be in resonance with a range of sea states while remaining cost competitive in the marketplace. A simple system to change, or tune, the natural frequency of the WEC to that of the prevailing wave would gain additional energy without substantial hardware or long-term maintenance costs.

### BRIEF SUMMARY OF THE INVENTION

The present invention provides a method to tune the natural frequency of a WEC by modifying the effective gravity force vector acting on the WEC. Changing the natural frequency of a WEC to match the frequency of the prevailing wave condition allows the WEC to be in resonance and harvest more energy. The method is passive and does not require substantial hardware investment or energy expense, active mechanisms, or computing power to forecast the next wave. The method may be combined with other known methods to increase the energy harvest of the WEC.

In one aspect, the method changes the natural frequency of a WEC having a translational PTO by manipulating the angle of the displacement path of a WEC body relative to gravity. The angle of inclination of the translation relative to gravity determines the magnitude of the force of gravity acting along the displacement path, thereby changing the effective translational spring constant and the natural frequency of the WEC.

In another aspect, the method changes the natural frequency of a WEC having a rotational PTO by changing the equilibrium angle of a rotating WEC body relative to the direction of gravity. Changing the equilibrium angle changes the magnitude of the torque due to gravity when the WEC body is displaced from its equilibrium state, thereby changing the torsional spring constant and the natural frequency of the WEC.

In further aspects, embodiments of the invention utilize a spar buoy as an inertial body, wherein a draft of the spar buoy is adjusted to change the inclination or equilibrium angle, thereby tuning the natural frequency of the WEC in response to changing sea states.

### BRIEF DESCRIPTION OF THE DRAWINGS

FIG. 1 is an illustration of the mechanical oscillating system of the present disclosure embodying the method to achieve resonance for a WEC with a translational PTO.

FIG. 2A is a two-dimensional illustration of a common WEC design having a translational PTO in a vertical orientation.

FIG. 2B is an illustration of the mechanical oscillating system of the common WEC design of FIG. 2A having a translational PTO in a vertical orientation.

FIG. 3 is an illustration of an embodiment of a WEC design employing the method of the present disclosure to achieve resonance for a WEC with a translational PTO.

FIG. 4 is an illustration of the mechanical oscillating system of the present disclosure embodying the method to achieve resonance for a WEC with a rotational PTO.

FIG. 5 is an illustration of an embodiment of a WEC design employing the method of the present disclosure to achieve resonance for a WEC with a rotational PTO.

### DETAILED DESCRIPTION OF THE INVENTION

A key desire of all utility machines is to maximize the desired output for a minimum input cost. For a WEC, it is desirable to maximize energy output relative to the overall cost of investment. In general, most WEC designs are not cost competitive because they do not generate sufficient energy for the high cost of the WECs.

The variety of WEC designs is large, but the foremost consideration is the amount of power a WEC design can harvest from ocean waves. WECs generally consist of bodies of any shape and size moving relative to one another that absorb power from the waves. Many WECs are two-body systems connected with a PTO, though more than two WEC bodies may be used. One body may be an inertial body that does not respond significantly to wave action, while another body moves readily with the waves. The inertial body may also be rigidly secured to the sea floor. The forces and velocity of the WEC bodies' relative motion are harvested at the PTO.

While the PTO energy conversion efficiency can impact a WEC's net energy output and cost competitiveness, an inefficient PTO may be readily substituted with another PTO for most WEC designs. Many PTO energy conversion mechanisms have been proposed, such as hydraulic pressure, air compression, or direct electricity generation. Each PTO has advantages and disadvantages, but the PTO represents a secondary energy conversion from the mechanical power generated by the WEC.

Most WECs are mathematically analyzed as an oscillating mechanical system of a mass, spring, and damper, where the relative motion of the WEC bodies driven by wave action is represented by an oscillating driving force on the mass. The dynamics of the WEC bodies arise from the interacting forces of waves, gravity, buoyancy, and fluid mechanics. The analysis of these forces is body-geometry dependent and can be involved. Nevertheless, it is often sufficient to use a simple mathematical model of an oscillating mechanical system to describe the general behavior of these WECs.

As an oscillating power source, wave energy harvest is maximized when the oscillating mechanical system is in resonance with the wave. An analogy of a WEC as an oscillating mechanical system is the bar pendulum, which has a natural oscillation frequency in the absence of driving forces. When a free oscillating energy source drives the bar pendulum, harvesting that energy with a PTO is at a maximum when the natural frequency of the bar pendulum equals the frequency of the free energy source. However, the frequency of wave energy changes regularly.

The challenge for most WEC designs is the ability to change the natural frequencies of the WECs to match the ocean wave frequencies. Many control methods to achieve resonance have been introduced and attempted. The vast majority can be categorized as active control methods, reactive impedance control, model predictive control, or frequency tuning. Significant research and development efforts have been made in this field [Ringwood, Appl. Ocean Res., Vol. 158, 2025, 104514] and are ongoing to make wave energy cost competitive.

In active control methods such as latching or declutching, the WEC body motion is restrained or released to match the wave frequency. There is much prior art related to these methods (e.g. GB 1587344, U.S. Pat. No. 435,551, EP 2315935 B1, etc.). The equivalent of these methods in the bar pendulum analogy is temporarily holding the bar pendulum when it comes to a momentary stop as it changes direction, or alternately making it swing faster so that its frequency matches that of the driving force. These control strategies involve components such as springs, clutches, or ratchets that either restrain or release the WEC bodies or the PTO components.

Another group of control strategies to achieve resonance is identified as reactive impedance control, where the spring constant and PTO damping constant are adjusted so that the natural frequency of the WEC matches the frequency of the incoming waves. The rough analogy for the bar pendulum is increasing or decreasing the velocity of oscillation to match the driving frequency by changing the amount of energy absorbed. The limitation of reactive impedance control is that the range of frequency change is limited, and high costs are involved if the range is increased to match the ocean's range of wave frequency.

Other control methods involve predicting the next wave crest or trough and modifying the WEC behavior to increase power output accordingly (e.g. EP 2315935 B1 and U.S. Pat. No. 11,802,537). These predictive control methods are sometimes combined with active control or impedance matching methods. Disadvantages of predictive methods include the need for computing power to forecast the next wave and difficulty with real, irregular ocean waves.

Frequency tuning is another known method to achieve resonance, but many known methods have a narrow band of practical frequency change relative to the ocean's wide range of wave frequencies. Other tuning methods require hardware such as springs or accumulators (e.g. U.S. Pat. No. 10,190,568 and Tan et al. [Ocean Eng., Vol. 254, 2022, 111347]). Additional hardware subjected to the high loads of a WEC is likely to increase reliability issues and long-term maintenance costs.

Accordingly, it is desirable to have a tuning method that can reach the majority of ocean wave frequencies without incurring significant initial investment costs or long-term reliability issues. The ability to increase the energy output through resonance will increase revenues and make WECs an economically competitive energy source.

Many WEC designs can be categorized into one of two groups in which the PTO absorbs energy in a translational motion or in a rotational motion. In each, the forces to drive the PTO come from the WEC bodies. The two PTO categories refer to the primary form of WEC body motion, and not to any secondary energy transfer mechanism. A translational WEC with a rack and pinion PTO, for example, harvests power from the translational motion of the WEC body, which results in pinion rotation to generate energy. The pinion rotation is a secondary energy transformation within the PTO mechanism.

The present invention discloses a method to achieve resonance for WECs having translational and rotational PTOs through manipulation of the WEC body's displacement vector relative to the gravity vector.

It should be noted that while real waves in the ocean are complex and three-dimensional, ocean waves generally propagate in a front such that WECs can be illustrated with a two-dimensional cross-sectional image. WEC body geometries may be of any shape, but these geometries typically have an axis of symmetry, such as a cylinder, a sphere, or a hemisphere. The illustrations herein are simplified to a two-dimensional side view of the WEC bodies for a wave propagating from left to right or right to left.

### Translational PTO WECs

WECs can be modeled as two-body systems to predict the fundamental oscillating dynamics. More than two bodies may be used in a WEC design, but WECs typically have one body moving readily with the surface waves relative to a second inertial body that is less responsive to waves. The inertial body may also be fixed to the seabed or shore. The resulting relative motion of the two bodies is converted by the PTO into harvested energy.

The analysis of WEC motion is complex due to hydrodynamic forces that depend on the geometry of the WEC bodies and other factors. Nevertheless, a WEC's oscillation in waves can be adequately modeled as an oscillating mechanical system represented by a mass, spring, and damper. The simple mathematical model works well to illustrate the dynamics of the method even though it does not take into account other forces such as added mass or drag on the WEC body.

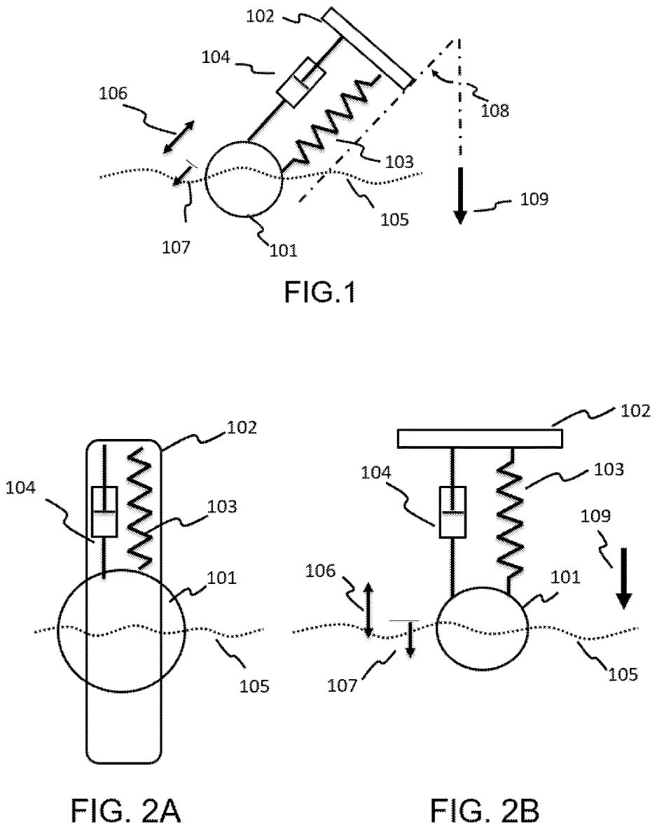

The method of changing the natural frequency of the present disclosure is illustrated in FIG. 1, showing a WEC design modeled with a WEC body, 101, and an inertial WEC body, 102, connected by a spring 103 and a damper 104 representing the PTO. The WEC is driven by waves, 105, generating a time-dependent driving force, shown by a vector arrow, 106, represented mathematically as P(t), acting on the WEC body 101. The net displacement of the WEC body 101 is shown by a displacement vector arrow, 107, to represent the mathematical variable x(t), and the entire WEC is restricted to travel at an inclination angle, 108, represented by the mathematical variable α, relative to the direction of gravity. A vector arrow, 109, indicates the direction of gravity.

The illustrations in FIG. 1 are graphical representations of the mechanical components in mathematical modeling. The bodies 101 and 102 can be embodied by a variety of body geometries. For example, the WEC body geometries may be spheres, cylinders, rectangles, or any other shape. The WEC body element 101 moves relative to the inertial or reaction body 102. The PTO 104 can represent any of the many known energy conversion mechanisms. The spring 103 may be a real spring or a mathematical representation, because the dynamics between gravitational force and buoyancy exhibit spring-like behavior.

A typical heaving, two-body WEC is shown in FIG. 2 to contrast and illustrate the benefits of the invention. FIG. 2A depicts a WEC body 101 and an inertial WEC body 102 connected to a spring element 103 and a PTO element 104, and driven by waves 105. The spring element 103 may be an actual physical component or a mathematical representation of the oscillation dynamics of the WEC. The WEC body 101 is driven by waves 105 to be displaced relative to the second WEC body 102. The second WEC body 102 may be rigidly attached to the shore or seabed, or may be a floating body less responsive to waves. This system is modeled as a mass, spring, damper system oscillating in the vertical direction, aligned with gravity as shown in FIG. 2B.

A significant number of known WECs employ this generic design of FIG. 2, and these systems have not proven cost effective. These designs were attempted and failed, resulting in the need for control methods to achieve resonance. In over 200 years since the earliest WEC patent, many prior art references (e.g., U.S. Pat. Nos. 581,267 and 7,199,481) have disclosed translational motion in the vertical direction, generating energy at the PTO from this translational motion. Most of these designs have not been shown to be cost effective; they simply do not harvest sufficient energy.

The motion of the WEC system of FIG. 2B is governed by Equation (1), where x denotes the net displacement 106 of body 101 from equilibrium. The spring constant is k, used to represent the spring 103 as the net restoring force between gravity 109 and the buoyancy force of the displaced fluid acting on the oscillating WEC body 101 with mass m. This restoring force is a function of the displacement from equilibrium 106, x(t), where t is time. The terms x′ and x″ are the velocity and the acceleration of the WEC body, respectively. The damper 104 is modeled as a damping constant c, used to model the power absorbed by the PTO. At equilibrium, x=0, the buoyancy force is equal to the weight of the WEC body. The net driving force of waves in the x direction, P(t) shown as 106 in FIG. 2 is modeled as having a driving wave force amplitude P with frequency ω_{f}.

m·x″+c·x′+k·x=P·sin (ω^{f}t) (1)

This equation of motion is a well-known linear differential equation, and the natural frequency of the system is given by Equation (2):

ω=√(k/m) (2)

This pure heave WEC system generates substantial energy if the wave frequency ω_{f} is equal to ω in Equation (2). Numerous prior art show WECs that travel only in this vertical direction and harvest energy from the heaving motion. These heaving WECs perform well only if the ocean frequency is the same as the WEC's natural frequency.

The invention allows a typical WEC of the kind shown in FIG. 2 to tune its natural frequency to achieve resonance by changing the effective vector of gravity on the WEC. When the generic WECs of FIG. 2 have their motion tilted and constrained to move at an incline angle relative to gravity, as shown in FIG. 1, the force of gravity is changed by a factor of the cosine of the angle of the incline, 108, α.

The equation of motion governing this inclined oscillating system is also Equation (1), by changing the coordinate system to reference the new direction for convenience. The displacement variable 107, x(t), and the net wave force 106, P(t), acting on the WEC bodies in FIG. 2 are now defined along the incline shown in FIG. 1. Along this inclination axis, the force of gravity on the system is m·g·cos(α), and the spring constant in Equation (2) is changed accordingly. The oscillating system model of the WEC will have the same equation of motion as Equation (1), where k is replaced by k·cos(α), and the natural frequency is given by:

ω=√(k·cos α/m) (3)

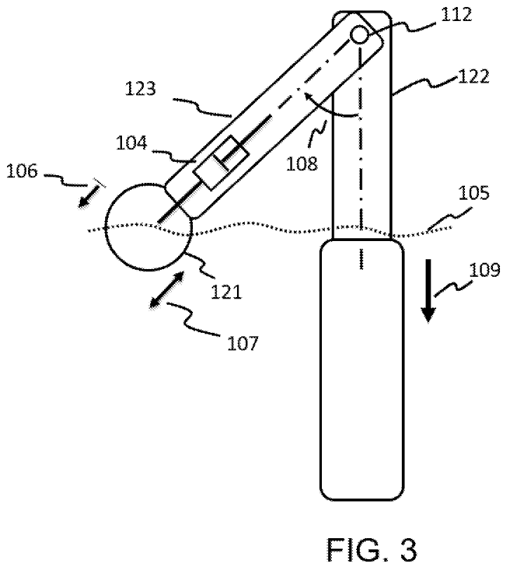

A WEC design of FIG. 3 employing Equation (3) can be used to select an α value that renders the natural frequency of the WEC ω identical to or as close as possible to ω_{f} of the prevailing sea state. At α=0 degrees, the natural frequency of the system is again that of the model of FIG. 2.

An embodiment of a floating-body WEC that harvests energy as represented by FIG. 1 is shown in FIG. 3, where the two-body WEC comprises a floating sphere, 121, moving relative to a spar buoy, 122. The spar buoy acts as the inertial body and includes a straight arm or beam, 123, hinged at a pivot, 112. The floating sphere 121 moves in translation along the direction of the arm. The damper 104 shown in FIG. 3 can be any known PTO mechanism, such as a hydraulic piston and cylinder or a rack and pinion mechanism. The wave 105, the net driving force 106, and the displacement 107 are as shown in FIG. 1, which is also the representative mathematical model for this WEC design. The floating sphere 121 can be replaced with other suitable geometries, such as a cylinder or a rectangular box, but this embodiment takes advantage of the spar buoy 122 as the inertial body.

The spar buoy is a simple and advantageous geometry for a WEC employing the present method. A spar buoy is a long, slender buoy floating in a vertical orientation with a substantial portion of its length submerged under the water surface. A typical spar buoy is cylindrical, with a length much greater than the diameter. The equilibrium orientation of a normal spar buoy in water is aligned with the direction of gravity, unless intentionally designed and weighted to alter the equilibrium orientation. The spar buoy by itself generally has a small pitch response to waves. In addition, a change in draft of the spar buoy does not significantly change the hydrodynamics of the floating body.

As defined by the direction in FIG. 3, the inclination angle α can range from 0° to approximately 90°. However, as the inclination angle 108, α, approaches 90°, the WEC body 121 will have substantially horizontal translation and the analysis becomes inapplicable because the spring constant k between gravity and buoyancy forces breaks down. A physical spring may be used in the angles near 90°.

The effective vector of gravity on the WEC, as indicated by the inclination angle α, 108, can be changed by any known means. The pivot 112 of FIG. 3 can be raised or lowered by the spar buoy 122 or mechanically moved up, down, left, or right to change the inclination angle α, 108. The lever length can also be mechanically increased or decreased to change the inclination angle 108.

The embodiment of FIG. 3 shows the pivot point 112 above the water level. The method is also effective if the pivot point 112 is below the water level, where the range of angles will be between 90° and 180° as defined in FIG. 3. However, additional bodies in the water may change the hydrodynamic forces impacting the WEC.

The method applies to the generic WEC of FIG. 1 for all shapes of WEC bodies 101 and 102. Any variety of PTO mechanisms may be deployed as the PTO 104 for a WEC employing this method. The embodiment shown in FIG. 3 uses an arm or beam 123 to restrict the translational motion to be at an angle α, 108, but any other form of constraint on the angle of motion may be used. The method may employ any known means, such as slots, ramps, or cables, to restrict the translational motion of the WEC body to be at an angle relative to gravity as illustrated in FIG. 1.

The method allows WECs having a translational relative motion between bodies to change the WEC's natural frequency. The embodiment of FIG. 3 is one means to tune the natural frequency of the WEC.

### Rotational PTO WECs

Another common form of a two-body WEC is one in which rotation of one body relative to the other, known as pitching, is converted by a rotating PTO into useful energy. As before, one body is less reactive to wave action than the second body, which may be rigidly secured to the seabed or ground. The two bodies may be connected directly at a pivot point, or a third member such as a lever may be used to connect the two bodies in rotation. The connecting member may take any shape and form, but a lever is the simplest form for generating a torque to power a rotating PTO.

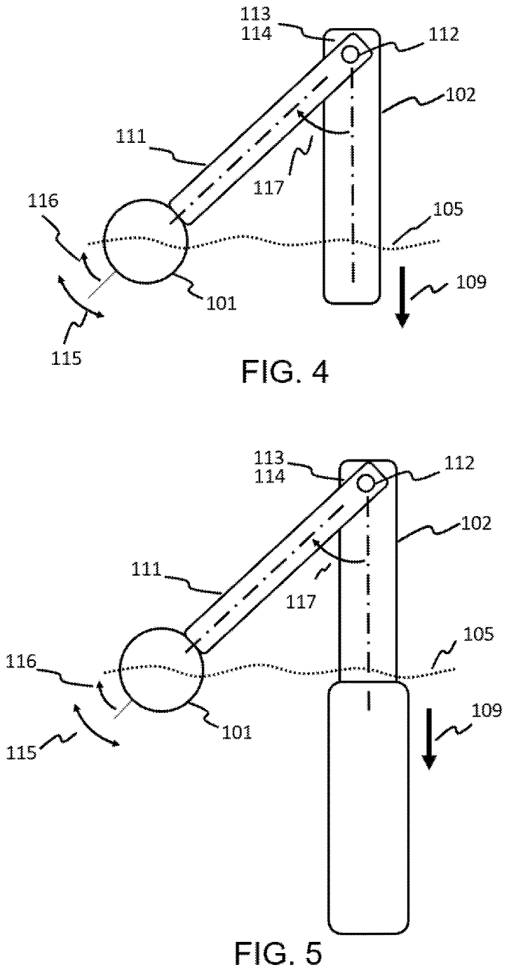

FIG. 4 shows a representative model of a WEC design with a rotational PTO, modeled with a WEC body 101, an inertial WEC body 102, connected by a lever 111 rotating about a pivot point 112. A torsional spring 113 and a rotational PTO 114 are elements in the WEC but are not shown in the illustration for simplicity. The WEC is driven by waves 105, generating a time-dependent net torque shown by the arrow 115, representing the variable τ(t), acting on the WEC body 101. Gravity's direction is shown by a vector arrow 109. The relative angular displacement of the WEC body 101 is represented by an arrow 116, representing the mathematical variable θ(t).

In the absence of waves, the two bodies 101, 102 and the lever 111 are at rest at any angle, referred to as an equilibrium angle 117 representing the mathematical variable α. This equilibrium angle 117, α, can be 0°, resulting in a vertical lever, or any value up to 90° where the lever is horizontal. When the equilibrium angle α, 117, is at 0°, the equation of motion is similar to that for a forced bar pendulum.

Considerable prior art describes this rotational motion, known as pitching. Many of these pitching designs are likewise not cost effective and employ control methods to increase their energy harvest.

FIG. 4 is the rotational equivalent of the translational mass, spring, damper oscillating system shown in FIG. 2B. Linear displacement is replaced by angular displacement, linear velocity is replaced with angular velocity, and linear force is replaced with torque. The spring constant 113 is a mathematical representation of the physics of the oscillating mechanical system. An abbreviated analysis of the dynamics for the system of FIG. 4 is shown using the torsional equation of motion, Equation (4).

J·θ″+cᵣ·θ′+kᵣ·θ=τ·sin (ω^{f}t) (4)
where:
J=mass moment of inertia of the lever;
θ″=angular acceleration;
θ′=angular velocity;
θ=angular displacement;
cᵣ=damping coefficient;
kᵣ=torsional spring constant;
τ=net tangential dynamic force amplitude on the lever due to wave and buoyancy forces;
ω_{f}=wave excitation frequency; and
t=time.

The natural frequency of the oscillatory system is given by Equation (5):

ω=√(kᵣ/J) (5)

If the rotational natural frequency ω of Equation (5) is equal to the frequency of the driving force ω_{f} in Equation (4), the WEC is in resonance. The magnitude of the torsional spring constant kᵣ is given by Equation (6):

kᵣ=ρ·g·L²·A_{w}·sin α (6)
where:
ρ=density of sea water;
g=gravitational constant;
L=length of the lever; and
A_{w}=waterplane area of the WEC body 101 at equilibrium.

The angular natural frequency of the rotational system therefore becomes:

ω=√(ρ·g·L²·Aᵥ·sin α/J) (7)

Equation (7) shows that the angular natural frequency of a rotational PTO WEC can be changed by changing the equilibrium angle α, 117. These equations demonstrate that the natural frequency of the rotational PTO WEC can be tuned to be close or equal to the frequency of the prevailing waves.

An embodiment of a floating-body WEC with a rotational PTO as represented by FIG. 4 is shown in FIG. 5. The WEC body 101 is a sphere, though it may take other geometries, while the WEC body 102 is a spar buoy. The advantages of the spar buoy geometry as the inertial body are the same in this rotational PTO case as in the translational PTO of FIG. 3. The spar buoy maintains an approximate vertical orientation relative to gravity, and changing the draft of the spar buoy allows the WEC to control the equilibrium angle 117 to maximize WEC harvest according to the prevailing sea state. The torsional PTO 114 can be any known PTO mechanism and is not shown for simplicity. Again, the torsional spring 113 in this embodiment is a mathematical representation of the oscillating dynamics and not necessarily a physical item.

An embodiment of U.S. Pat. No. 9,309,860 B2 illustrates a WEC design represented by FIG. 5. The present invention discloses the method to maximize energy harvest from such a WEC design. The rotational WEC of FIG. 5 can take advantage of the wave surge when the equilibrium angle α, 117, is 0°.

The invention discloses the method of changing the natural frequency of a rotational PTO WEC by changing the equilibrium angle 117 of the lever 111. In a rotating lever, torque due to gravity changes as the angle of the lever changes. Changing the equilibrium angle 117 therefore changes the magnitude of the torque 115 referenced to the equilibrium angle 117. The equivalent rotational spring constant 113 changes, thereby changing the natural frequency of the angular oscillating system.

The analogous bar pendulum in this method is one that can oscillate around angles other than zero. A bar pendulum oscillating in air can only oscillate around a 0° angle as defined by the convention herein. The bar pendulum of this method changes its natural frequency by oscillating around other equilibrium angles. This feature is unique to bar pendulums used as a WEC.

The effective vector of gravity on the WEC, as indicated by the equilibrium angle α, 117, can be changed by any known means. The pivot 112 of FIG. 5 can be raised or lowered by the spar buoy 122 or mechanically moved up, down, left, or right to change the equilibrium angle α, 117. The lever length can also be mechanically increased or decreased to change the equilibrium angle α, 117. The equilibrium angles 117 discussed so far have ranged between 0° and 90°, but any angle from 90° to 180° mirrors that from 0° to 90°. The pivot 112 may be above or below the water level. While the vectorial influence of gravity on the WEC still applies under water, the lever as a body under water will also be impacted by hydrodynamic forces.

The rotational PTO WEC in FIG. 4 does not show the PTO element 114, but it may be located in or on any of the body elements, the WEC bodies 101, 102, or the lever 111. There may be two hinge points at both ends of the lever, or just one at body 102. The bodies 101 or 102 may be integrated to the lever 111 or act as the lever.

The method of changing the natural frequency of a WEC has been disclosed as a means to achieve resonance and improve energy harvest. The same said method may be used to reduce the WEC's response to waves. A WEC's response to waves may need to be reduced when strong wave conditions such as storms impose significant loads on the WEC and threaten its structural integrity.

A brief comparison between the translational and rotational PTOs is warranted. The equilibrium angle 117 and the angle of inclination 108 are assigned different reference numerals only to indicate their respective applications. In both cases, the angle serves to modify the vectorial force of gravity on the WEC dynamics. In the case of the translational PTO, the angle changes the magnitude of the force on the WEC bodies; in the case of a rotational PTO, the angle modifies the torque relative to the equilibrium point, the zero value for the rotational PTO. The magnitude of the angle depends on the sea state and the type of WEC being analyzed.

The modification of the gravitational vector relative to the WEC body translation or rotation may be combined with other known frequency tuning methods to increase the range of frequencies to which the WEC can be tuned. Elements of the WEC such as the lever length and waterplane area shown in Equation (6) can be designed to be controlled to change the natural frequency of the WEC.

### Conclusion of the Detailed Description

The invention discloses a method for WECs to maximize energy absorption according to the prevailing sea state by modifying the effective vector of gravity on the WEC to change its natural frequency and achieve resonance. The method is applicable to a variety of WEC designs where the WEC bodies and PTOs exhibit relative motion in translation or rotation.

In the case of the translational PTO WEC, the method changes the effective gravity force vector on the WEC and PTO mechanism to achieve resonance with the prevailing wave conditions. In the case of a rotational PTO WEC, the method changes the equilibrium angle of one WEC body relative to the other WEC body to change the natural frequency and achieve resonance.

The method is passive and low cost. Whether a WEC has a translational or rotational PTO, the method maximizes WEC energy extraction by manipulating the effective gravitational force amplitude. The inclination or equilibrium angles of the translational or rotational PTO WECs can be changed as wave conditions change over time. The method may be combined with other known methods to increase its energy harvest effectiveness, and can generate a substantial return on investment for WECs.

While the foregoing describes particular embodiments, it will be understood by those of ordinary skill in the art that various modifications may be made without departing from the scope of the invention. The specific embodiments and reference numerals used are illustrative and not limiting.

What is claimed is:

1. A method of tuning a natural frequency of a wave energy converter (WEC), the method comprising:
modifying an effective gravitational force vector acting on at least one body of the WEC by adjusting an angle between a displacement path of the body and a direction of gravity, thereby changing the natural frequency of the WEC.

2. A method of tuning a natural frequency of a wave energy converter (WEC) comprising a first WEC body and a second WEC body, and having a translational power take-off (PTO) mechanism, the method comprising:
constraining relative translational motion between the first WEC body and the second WEC body to a path inclined at an angle relative to the direction of gravity; and
adjusting the angle to modify an effective spring constant of the WEC oscillating system, thereby tuning the natural frequency of the WEC.

3. A method of tuning a natural frequency of a wave energy converter (WEC) comprising a first WEC body and a second WEC body connected at a hinge, and having a rotational power take-off (PTO) mechanism, the method comprising:
changing an equilibrium angle between the first WEC body and the second WEC body relative to the direction of gravity; and
modifying a torsional spring constant of the WEC oscillating system through the changed equilibrium angle, thereby tuning the natural frequency of the WEC.
